(19) United States
(12) Patent Application Publication
(10) Pub. No.: US 2003/0174057 A1
(43) Pub. Date: Sep. 18, 2003

(54) Firearm detection system including door fixing device

(76) Inventors: Suk-Joon Kim, Seoul (KR); Byong-Yong Park, Seoul (KR)

Correspondence Address: SEYFARTH SHAW, 55 EAST MONROE STREET, SUITE 4200, CHICAGO, IL, 60603-5803, US

(21) Appl. No.: 10/318,461

(22) Filed: Dec. 13, 2002

(30) Foreign Application Priority Data
Mar. 12, 2002 (KR) 2002-13277

(51) Int. Cl. G08B 13/00

(52) U.S. Cl. 340/541; 340/523; 340/551; 340/572.1

(57) ABSTRACT

A firearm detection system for inspecting whether a person passing through a gate positioned near a metal door is carrying a firearm is disclosed. The system comprises a door fixing device; a first sensor mounted on a doorframe to detect the entrance of a person into the door; a second sensor mounted on an entrance side of the gate to detect the entrance of the person into the gate; a third sensor mounted on an exit side of the gate to detect the exit of the person from the gate; and a microcomputer for controlling the operation of the door fixing device based on the detection results by the three sensors. The efficiency in use is maximized because a door fixing device operates to stop the movement of a door during the inspection procedure so as to prevent the generation of an electromagnetic field by the movement of the door made of similar material to the firearm, thereby preventing a false alarm signal from being generated by the movement of the door when a person carrying no firearm enters the gate.

### BACKGROUND OF THE INVENTION

1. Field of the Invention

The present invention relates to a firearm detection system, and more particularly to a firearm detection system installed at a specific secure area for inspecting whether persons entering or exiting the area are carrying a weapon that can injure other persons, wherein there is provided a door fixing device for stopping movement of a door during inspection of whether the person is carrying a firearm, so as to prevent a false alarm signal from being generated by electromagnetic field diffusion which is caused by the movement of the door made of similar material to the firearm.

2. Description of the Related Art

A firearm detection system is generally installed at a secure area such as an airport or a national government office to detect firearms that may be exist with persons entering or exiting the area, without manually searching their bodies, so as to be convenient to these persons.

Recently, as crimes involving firearms has increased, the necessity for provision of the firearm detection system is increased.

The system irradiates an electromagnetic field toward the person entering or exiting the area, receives a return electromagnetic field, and interfaces with a computer to determine if the person is carrying a firearm based on the intensity variation of the received electromagnetic field, and generates an alarm signal if it is determined that the person is carrying a firearm.

FIG. 1 is a view showing the search gate of a firearm detection gate of the prior art.

As shown in this figure, a firearm search gate 10 includes a pair of first and second panels 11 and 12 disposed to face each other. A field transmission coil 13 is mounted along the edge of the first panel 11 to generate an electromagnetic field of predetermined intensity. Field reception coils 14 and 15 are mounted on the second panel 12 to receive an electromagnetic field generated from the field transmission coil 13 and an electromagnetic field diffused from a firearm.

FIG. 2 is a block diagram schematically showing configuration of the firearm detection system of the prior art.

As shown in this figure, the system comprises an oscillator 20, the field transmission coil 13, the field reception coils 14 and 15, amplifiers 21 and 22, a comparator 23, a microcomputer 24, an alarm 25, a display device 26, and an input unit 27. The oscillator 20 provides a pulse wave of a predetermined frequency. The field transmission coil 13 receives an induced current from the oscillator 20 and generates an electromagnetic field. The transmission coils 14 and 15 detect any electromagneticity generated from the transmission coil 13. The amplifiers 21 and 22 amplify signals from the reception coils 14 and 15, respectively. The comparator 23 compares signals from the amplifiers 21 and 22. The microcomputer 24 analyzes data from the comparator 23 using a previously stored algorithm to recognize a firearm. According to the output of the microcomputer 24, the alarm 25 and the display unit 26 generate audio and visual alarm signals indicating detection of a metal, respectively. The input unit 27 is used for inputting data on metal and firearms to be searched.

When a person carrying such a contraband metal passes through the gate 10, the first and second reception coils 14 and 15 mounted on the panels 12 detect different intensities of the electromagnetic fields. In response to this difference, the microcomputer 24 enables the alarm 25 and the display unit 26 to generate audio and visual alarm signals.

However, the firearm detection gate is generally installed near a door. Therefore, in the case where the door is also made of metal, it is highly possible that the swing of the door causes diffusion of the electromagnetic field generating a false alarm signal, leading to suspicion of a person carrying no firearm.

### SUMMARY OF THE INVENTION

Therefore, the present invention has been made in view of the problem, and it is an object of the present invention to provide a firearm detection system provided with a door fixing device for stopping the movement of a door during the procedure of inspecting person entering or exiting a secure area for a firearm, so as to prevent a false alarm signal from being generated by an electromagnetic field diffusion caused by movement of a door made of similar material to a firearm.

In one aspect of the present invention, there is provided a firearm detection system for detecting whether a person passing through a gate positioned near a metal door is carrying a firearm, the system comprising: a door fixing device for fixing the door; a first detection sensor mounted on a doorframe to detect the entrance of a person; a second detection sensor mounted on an entrance side of the gate to detect the entrance of a person into the gate; a third detection sensor mounted on an exit side of the gate to detect an exit of a person from the gate; and a microcomputer for controlling operation of the door fixing device based on the detection results of the first, second, and third detection sensors.

Preferably, the microcomputer controls the operation of the door fixing device in such a manner that the door is fixed simultaneously by the detection by the first detection sensor, and after entrance of a person into the gate is confirmed by the detection by the second detection sensor, the door fixed state is released at the same time when the exit of the person from the gate is confirmed by the detection by the third detection sensor.

Preferably, the door fixing device includes: first and second yokes disposed parallel to each other and including therein a solenoid connected to a power supply unit to receive electrical power therefrom; a plurality of disc-shaped metal desks positioned adjacent to the first and second yokes and having a center hole; and a stopper pin positioned between the first and second yokes and inserted into the center hole of the metal desks.

Preferably, the door fixing device is configured in such a manner that a gear is controlled using a solenoid, or that a plurality of gears are connected to a motor and the door is fixed by a reduction in the speed of the motor.

### BRIEF DESCRIPTION OF THE DRAWINGS

Other objects and aspects of the present invention will become apparent from the following description of embodiments with reference to the accompanying drawings in which:

FIG. 1 is a view showing a searching gate of a firearm detection gate of the prior art;

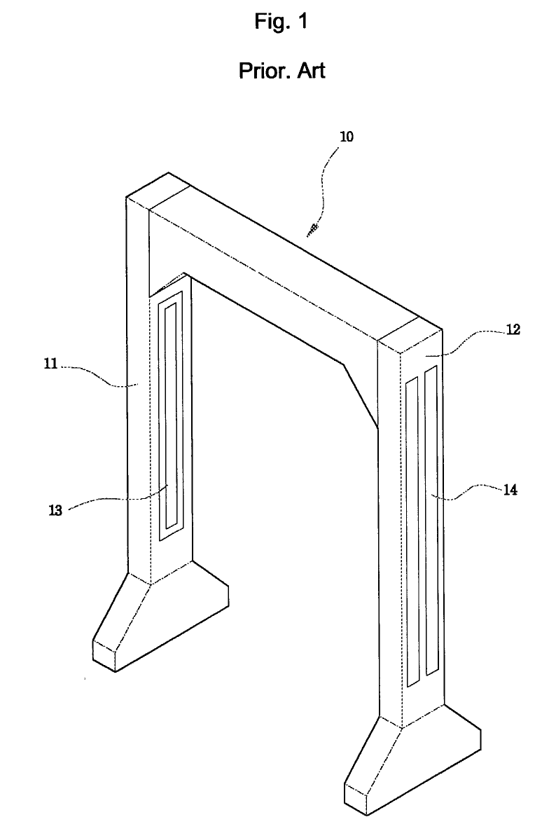

FIG. 2 is a block diagram schematically showing the configuration of the firearm detection system of the prior art;

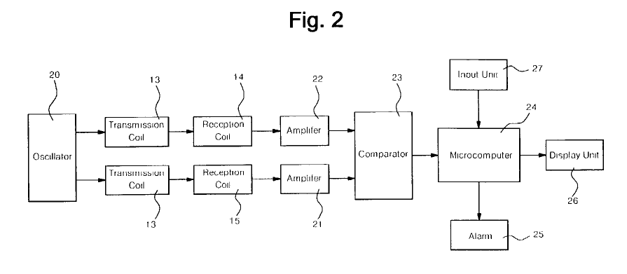

FIG. 3 is a view showing a firearm detection system equipped with a door fixing device according to one embodiment of the present invention;

FIG. 4 is a block diagram showing the configuration of the firearm detection system equipped with the door fixing device according to the present invention;

FIG. 5 is a flowchart schematically showing the operation of the firearm detection system equipped with the door fixing device according to the present invention;

FIG. 6 is a view showing the door fixing device according to an embodiment of the present invention.

### DESCRIPTION OF THE PREFERRED EMBODIMENT

Now, preferred embodiments of the present invention will be described in detail with reference to the annexed drawings. The preferred embodiments are described only for illustrative purposes, and thus the scope of the present invention is not limited thereto. In the drawings, the same or similar elements are denoted by the same reference numerals even though they are depicted in different drawings.

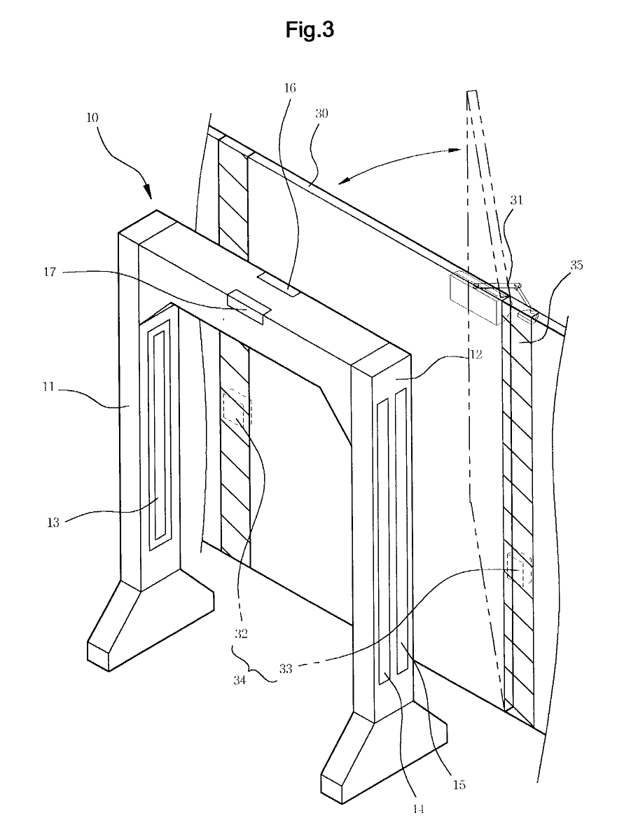

FIG. 3 is a view showing a firearm detection system equipped with a door fixing device according to one embodiment of the present invention.

As shown in this figure, a firearm detection gate 10 includes a pair of first and second panels 11 which are disposed to face each other. A field transmission coil 13 is mounted along the edge of the first panel 11 to generate an electromagnetic field (or a magnetic field) of a predetermined intensity. Field reception coils 14 and 15 are mounted on the second panel 12 to receive an electromagnetic field generated from the field transmission coil 13 and an electromagnetic field diffused from a firearm. A second detection sensor 16 is disposed on the entrance side of the gate to detect the entrance of a person, and a third detection sensor 17 is disposed on the exit side of the gate to detect the exit of the person.

The firearm detection system according to the present invention further comprises a door fixing device 31 mounted on a door 30 positioned near the gate 10, a first detection sensor 34 mounted on a doorframe, and a microcomputer (not shown) for controlling the operation of the door fixing device. The door fixing device 31 operates to fix the door 30. The first detection sensor 34 is composed of transmission and reception coils 32 and 33 to detect the entrance of the person into the door 30. Based on the detection results of the first, second, and third sensors 34, 16, and 17, the microcomputer determines whether to fix the door 30.

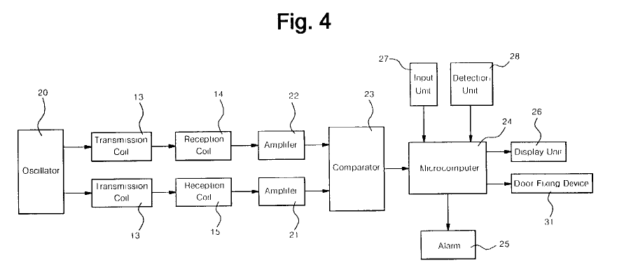

FIG. 4 is a block diagram showing the configuration of the firearm detection system equipped with the door fixing device according to the present invention.

As shown in this figure, the system comprises an oscillator 20, a field transmission coil 13, field reception coils 14 and 15, amplifiers 21 and 22, and a comparator 23. The oscillator 20 provides a pulse wave of a predetermined frequency. The field transmission coil 13 receives an induced current from the oscillator 20 and generates an electromagnetic field. The transmission coils 14 and 15 detect the electromagnetic generated from the transmission coil 13. The amplifiers 21 and 22 amplify signals from the reception coils 14 and 15, respectively. The comparator 23 compares signals from the amplifiers 21 and 22.

The system according to the present invention comprises a detection unit 28 (corresponding to the first detection sensor), a door fixing device 31, a microcomputer 24 (corresponding to the microcomputer mentioned above), an alarm 25, a display device 26, and an input unit 27. The detection unit 28 detects whether or not a person enters the gate. The door fixing device operates to fix the door. The microcomputer 24 analyzes data from the comparator 23 using a previously stored algorithm to recognize a firearm, and controls the operation of the door fixing device 31. According to the output of the microcomputer 24, the alarm 25 and the display unit 26 generate audio and visual alarm signals indicating detection of a metal, respectively. The input unit 27 is used for inputting data on metal and firearms to be searched.

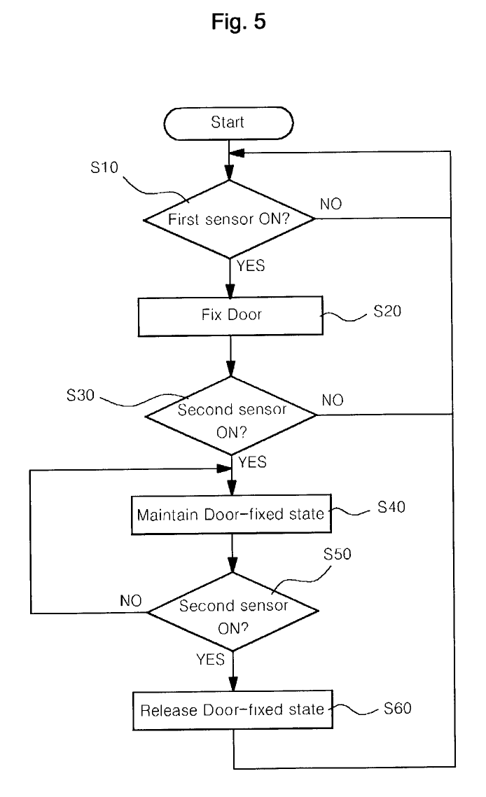

FIG. 5 is a flowchart schematically showing the operation of the firearm detection system equipped with a door fixing device according to the present invention.

When the door 30 swings open, the first detection sensor mounted on one side of the door detects the opened door to determine that a person is entering the door (S10), and, at the same time, the door fixing device 31 fixes the door (S20). Subsequently, the second detection sensor 16 mounted on the entrance side of the firearm search gate 10 detects that the person enters the gate (S30), and the fixing of the door is maintained (S40).

Subsequently, when the third detection sensor 17 detects that the person is exiting the gate (S50) the door fixed state is released (S60).

On the other hand, when a person passes through the gate opposite to the entrance direction, and thus the detection of the third detection sensor 17 is performed the first time, the door is not fixed.

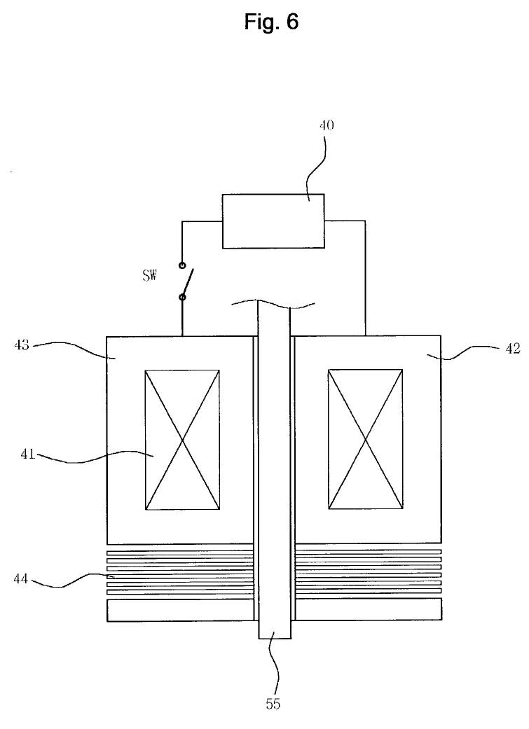

FIG. 6 is a view showing the door fixing device according to an embodiment of the present invention.

As shown in this figure, the door fixing device includes first and second yokes 42 and 43, a plurality of disc-shaped metal desks 44, and a stopper pin 45. A solenoid connected to a power supply unit 40 to receive electrical power is provided inside the yokes 42 and 43. The first and second yokes 42 and 43 are disposed parallel to each other. The metal desks 44 are positioned adjacent to the first and second yokes 42 and 43 and have a center hole. The stopper pin 45 is positioned between the first and second yokes and inserted into the center hole of the metal desks 44.

When the second detection sensor 16 detects the entrance of a person through the gate 10, a switch SW is turned on to allow a power to be supplied to the solenoid 41, thereby applying a magnetic force to the metal desks 44 to come into contact with each other.

As the metal desks 44 come into contact with each other, the stopper pin 45 inserted into the center hole of the metal desks 44 is fixed, thereby fixing the door.

Besides the embodiment mentioned above, the door fixing device may be configured in such a manner that a gear is controlled using a solenoid, or that a plurality of gears are connected to a motor and the door is fixed using a reduction in the speed of the motor.

As apparent from the above description, a firearm detection system equipped with a door fixing device maximizes efficiency of use, since the door fixing device operates to stop the movement of a door during the procedure of inspecting whether a person entering or exiting a secure area is carrying a firearm, so as to prevent generation of an electromagnetic field by movement of the door, made of similar material to the firearm, thereby preventing a false alarm signal from being generated by movement of the door when a person carrying no firearm enters the area.

Although preferred embodiments of the present invention have been described, it is to be understood that the invention is not limited thereto and that various changes and modifications may be made without departing from the spirit and scope of the invention.

What is claimed is:

1. A firearm detection system for inspecting whether a person passing through a gate positioned near a metal door is carrying a firearm, the system comprising:
a door fixing device for fixing the door;
a first detection sensor mounted on a doorframe to detect the entrance of a person into the door;
a second detection sensor mounted on an entrance side of the gate to detect the entrance of a person into the gate;
a third detection sensor mounted on an exit side of the gate to detect the departure of a person from the gate; and
a microcomputer for controlling operation of the door fixing device based on the detection results by the first, second, and third detection sensors.

2. The firearm detection system according to claim 1, wherein the microcomputer controls the operation of the door fixing device in such a manner that the door is fixed simultaneously with the detection by the first detection sensor, and after the entrance of the person through the gate is confirmed by the detection by the second detection sensor, the door fixed state is released at the same time when the exit of the person from the gate is confirmed by the detection by the third detection sensor.

3. The firearm detection system according to claim 1, wherein the door fixing device includes:
first and second yokes disposed parallel to each other and including therein a solenoid connected to a power supply unit to receive an electrical power therefrom;
a plurality of disc-shaped metal desks positioned adjacent to the first and second yokes and having a center hole; and
a stopper pin positioned between the first and second yokes and inserted into the center hole of the metal desks.

4. The firearm detection system according to claim 1, wherein the door fixing device controls a gear using a solenoid.

5. The firearm detection system according to claim 1, wherein the door fixing device induces the stoppage of a motor using a plurality of gears connected to the motor.
